(19) United States
(12) Patent Application Publication
(10) Pub. No.: US 2022/0195273 A1
(43) Pub. Date: Jun. 23, 2022

(54) DUCT SEALANT AND METHOD OF SEALING A DUCT

(71) Applicant: BCE Inc., Verdun (CA)

(72) Inventor: Christian Cousineau, Varennes (CA)

(21) Appl. No.: 17/557,795

(22) Filed: Dec. 21, 2021

Related U.S. Application Data
(60) Provisional application No. 63/129,308, filed on Dec. 22, 2020.

(51) Int. Cl. C09K 3/10; C08L 75/04; C08L 23/06

(52) U.S. Cl. CPC C09K 3/1021; C08L 2207/062; C08L 23/06; C08L 75/04

(57) ABSTRACT

The present disclosure relates to a duct sealant, a kit for preparing the duct sealant, and a method of sealing a duct. The duct sealant comprises a curable plastic and a plurality of plastic pellets disposed throughout the curable plastic. The duct sealant is able to provide desirable properties such as quick curing, ease of installation, requires only a small thickness, and sufficiently seals the duct from gases and liquids. The duct sealant has a cellular sealant structure when cured, as the plastic pellets introduce weaknesses into the sealant that allows for easy and quick breakage/removal of the duct sealant with no damage to cables such as fiber optic cables being run through the duct.

### CROSS-REFERENCE TO RELATED APPLICATIONS

The present application claims priority to U.S. Provisional Application No. 63/129,308, filed Dec. 22, 2020, the entire contents of which is incorporated herein by reference for all purposes.

### TECHNICAL FIELD

The present disclosure relates to sealing ducts, and in particular to a duct sealant and a method of sealing a duct using the duct sealant.

### BACKGROUND

Ducts are used to protect cables (e.g. electrical cables, telecommunications cables, etc.) running there-through. Duct sealant is inserted into the duct to seal the duct from gases and liquids at locations such as cable-entry into buildings, transitions between underground and aerial cables, etc.

When re-entering a duct that has been sealed using a duct sealant, such as to repair/replace cables in the duct or to run new cable, the duct sealant must be removed. Some existing types of duct sealant, such as epoxy-like compounds, have generally worked well with large copper cables. However, these types of duct sealant are very hard when cured, and are not desirable with the use of fiber optic cables that are being deployed by telecommunications providers today. Among other things, when re-entering a duct sealed with these epoxy-like duct sealants the technician is required to chisel off the duct sealant. It is very difficult to remove the duct sealant without damaging the fiber optic cables, which was previously not an issue when stronger copper cable was used.

Other types of duct sealants have been developed, such as expanding foam-like sealants that are softer than the epoxy-like sealants. These foam types of sealants are also not ideal because, among other things, there are typically many inches of foam to remove when accessing the cable in the duct, and there are challenges during installation to prevent the expanding foam from dripping into the area to be protected or into the building. Alternative duct sealants use a caulking material that is a natural cure product where days or weeks are required for product to cure properly, which is also not desirable because liquid could enter the duct before the sealant cures.

Accordingly, an additional, alternative, and/or improved duct sealant and method of sealing a duct remains highly desirable.

### BRIEF DESCRIPTION OF THE DRAWINGS

Features and advantages of the present disclosure will become apparent from the following detailed description, taken in combination with the appended drawings, in which:

FIG. 1A shows a representation of a duct having a cable running there-through;

FIG. 1B shows an enlarged sectional view of the duct of FIG. 1A;

FIG. 10 shows an enlarged view of the duct sealant;

FIG. 2A shows a representation of a first example type of kit for preparing the duct sealant;

FIG. 2B shows a representation of a second example type of kit for preparing the duct sealant;

FIG. 2C shows a representation of a third example type of kit for preparing the duct sealant; and

FIG. 3 shows a method of sealing a duct.

It will be noted that throughout the appended drawings, like features are identified by like reference numerals.

### DETAILED DESCRIPTION

In accordance with one aspect of the present disclosure, a duct sealant is disclosed, comprising: a curable plastic; and a plurality of plastic pellets dispersed throughout the curable plastic.

In some aspects of the duct sealant, the curable plastic and the plastic pellets have a different hardness.

In some aspects of the duct sealant, the duct sealant comprises approximately 60-80% w/w of the curable plastic, and approximately 20-40% w/w of the plastic pellets.

In some aspects of the duct sealant, the duct sealant comprises approximately 70% w/w of the curable plastic, and approximately 30% w/w of the plastic pellets.

In some aspects of the duct sealant, the plastic pellets are spherical in shape and have a diameter of less than or equal to 3/16 inches.

In some aspects of the duct sealant, the curable plastic comprises polyurethane.

In some aspects of the duct sealant, the plastic pellets comprise HDPE.

In accordance with another aspect of the present disclosure, a kit for preparing the duct sealant in accordance with any one of the above aspects is disclosed, comprising: at least one cartridge having stored therein a first component of the curable plastic and a second component of the curable plastic, the first and second components being separated from one another; and the plurality of plastic pellets.

In accordance with some aspects of the kit, the kit comprises two cartridges that respectively store the first component and the second component of the curable plastic.

In accordance with some aspects of the kit, the kit comprises one cartridge storing both the first component and the second component of the curable plastic, wherein the first component and the second component are separated by a breakable membrane.

In accordance with some aspects of the kit, the plurality of plastic pellets are dispersed in one of the first component or the second component.

In accordance with some aspects of the kit, the plurality of plastic pellets are provided separately from the at least one cartridge.

In accordance with another aspect of the present disclosure, a method of sealing a duct is disclosed, comprising: preparing a duct sealant compound comprising a curable plastic with a plurality of plastic pellets dispersed throughout the curable plastic; inserting the duct sealant compound into the duct; and allowing the duct sealant compound to cure.

In accordance with some aspects of the method, the method further comprises: prior to inserting the duct sealant compound into the duct, inserting a backing material into the duct, wherein the duct sealant compound is inserted into the duct to extend a length between the backing material and an opening of the duct.

In accordance with some aspects of the method, the length between the backing material and the opening of the duct is ¾ inches to 1 inch.

In accordance with some aspects of the method, a curing time of the duct sealant compound is between 30 minutes and 2 hours.

In accordance with some aspects of the method, the duct encloses a fiber optic cable.

In accordance with some aspects of the method, the curable plastic and the plastic pellets have a different hardness.

In accordance with some aspects of the method, the duct sealant compound comprises approximately 60-80% w/w of the curable plastic, and approximately 20-40% w/w of the plastic pellets.

In accordance with some aspects of the method, the duct sealant compound comprises approximately 70% w/w of the curable plastic, and approximately 30% w/w of the plastic pellets.

In accordance with some aspects of the method, the plastic pellets are spherical in shape and have a diameter of less than or equal to 3/16 inches.

In accordance with some aspects of the method, the curable plastic comprises polyurethane.

In accordance with some aspects of the method, the plastic pellets comprise HDPE.

The present disclosure relates to a duct sealant, a kit for preparing the duct sealant, and a method of sealing a duct. The duct sealant comprises a curable plastic and a plurality of plastic pellets disposed throughout the curable plastic. The duct sealant is able to provide desirable properties of duct sealants such as quick curing, ease of installation, requires only a small thickness, and sufficiently seals the duct from gases and liquids. Meanwhile, the duct sealant has a cellular sealant structure when cured, as the plastic pellets introduce weaknesses into the sealant that allows for easy and quick breakage/removal of the duct sealant with no damage to cables such as fiber optic cables being run through the duct.

While the present disclosure particularly describes the use of the duct sealant for sealing ducts with fiber optic cables installed by telecommunication providers, a person skilled in the art will readily appreciate that the duct sealant can be used in various other applications, such as with copper cables and coaxial cables, as well as in other industries, such as with use of electrical wiring.

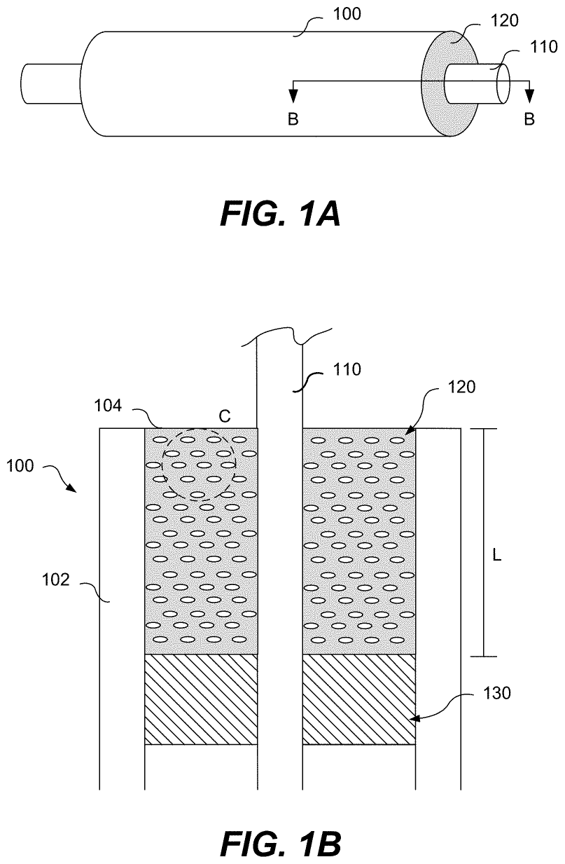

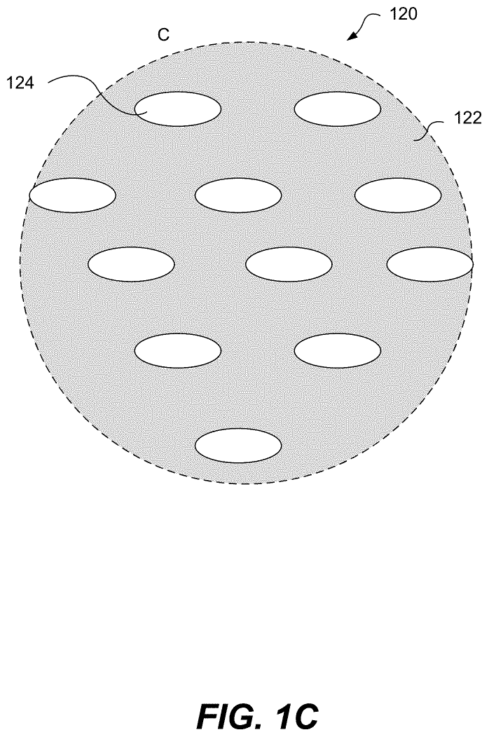

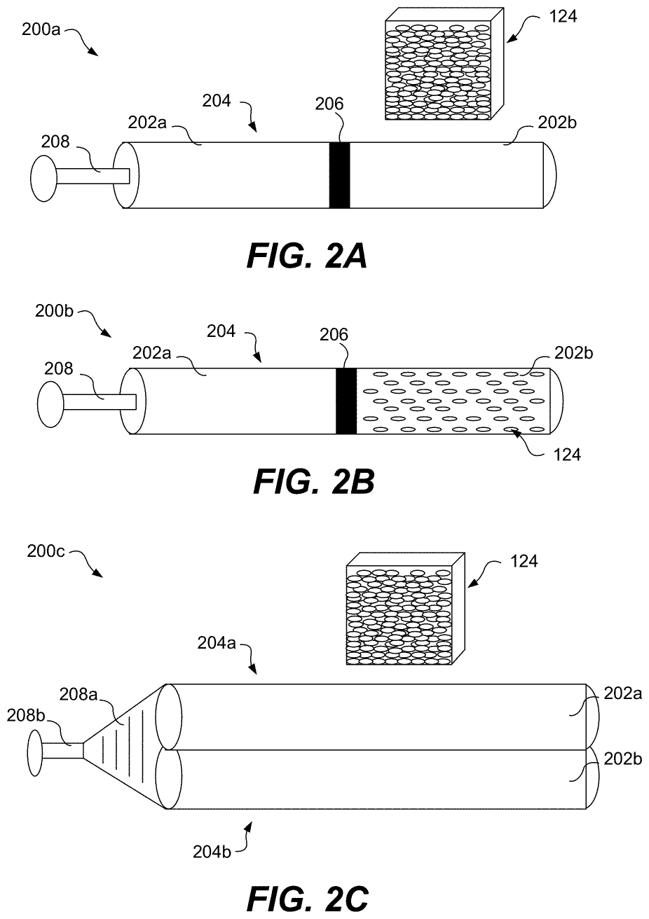

Embodiments are described below, by way of example only, with reference to FIGS. 1-3.

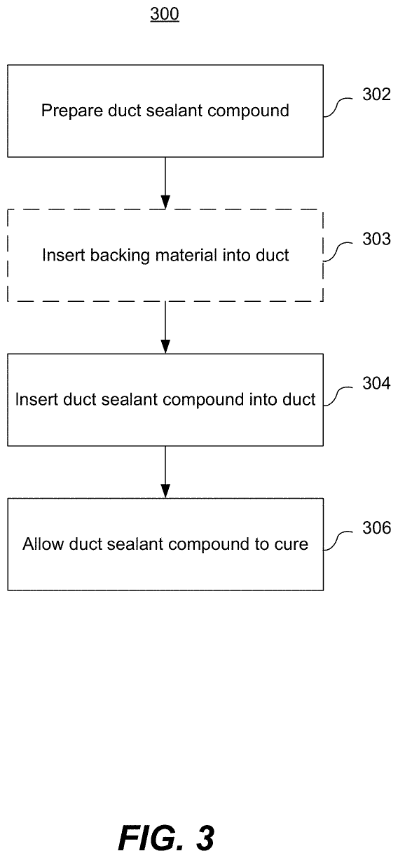

FIG. 1A shows a representation of a duct 100 having a cable 110 running there-through. The duct 100 is sealed at an opening thereof with a duct sealant 120. The duct sealant 120 is a cured plastic that prevents gas and liquid ingress into the duct 100. The duct sealant is described in more detail with respect to FIGS. 1B and 10.

The duct 100 is shown as having a cylindrical shape, but the shape of the duct 100 is not limited to such and may for example be square or rectangular in cross-section. The duct sealant 120 as disclosed herein is compatible with the duct 100 made of various types of materials, and with the cable 110 having various sheath materials and cable configurations, which do not affect the overall sealing performance of the duct sealant 120. Only a single cable 110 is shown running through the duct 100, however it would be appreciated that multiple cables may be running through the duct. Also, while the duct sealant 120 disclosed herein may be particularly advantageous when the cable 110 is a fiber optic cable as the duct sealant 120 is able to be easily removed upon re-entry without damaging the fiber optic cable, it would be appreciated that easy and fast removal of duct sealant upon re-entry is desirable regardless of the type of cable 110, and the duct sealant 120 can be used with other types of cables such as copper or coaxial cables.

FIG. 1B shows an enlarged sectional view of the duct of FIG. 1A taken along the lines B-B. FIG. 1B shows outer wall 102 of the duct 100 and the cable 110 running in the duct 100. The duct sealant 120 is disposed within the duct 100 so as to fill any voids in the duct 100 along a length L of the duct between an opening 104 of the duct 100 and a backing material 130. The duct sealant 120 as disclosed herein can seal the duct 100 from gases and liquids in accordance with relevant standards at a thickness of ¾ inches to 1 inch. That is, the length L of the duct 100 along which the duct sealant 120 is disposed advantageously may only be ¾ inches to 1 inch, which means there is less material of the duct sealant 120 that needs to be removed if the duct 100 is re-entered. The backing material 130 may be inserted into the duct 100 prior to inserting the duct sealant 120, and may for example be a foam strip, paper, cloth, and various other kinds of material that only permits insertion of the duct sealant 120 to the desired length L in the duct 100.

FIG. 10 shows an enlarged view of the duct sealant 120, corresponding to the circle “C” indicated in FIG. 1B. The duct sealant 120 comprises a curable plastic 122, and a plurality of plastic pellets 124 dispersed throughout the curable plastic. The duct sealant 120 thus has a cellular sealant structure whereby the plastic pellets 124 provide points of weakness that facilitates removal of the duct sealant 120, without compromising any of the sealing characteristics of the duct sealant.

The curable plastic 122 may for example be polyurethane, and the plastic pellets 124 may for example be high-density polyethylene (HDPE). The materials chosen for the curable plastic 122 and the plastic pellets 124 may in particular be chosen to have differences in hardness, as measured for example according to Shore “D” hardness scale. For example, the plastic pellets 124 may have a Shore “D” hardness in a range of 60-70, and the curable plastic 122 may have a Shore “D” hardness in a range of 70-80. It may also be advantageous to select materials such that the curable plastic 122 has high surface adhesion for adhering to the outer wall 102 of the duct and the cable 110, while the plastic pellets 124 have a low surface adhesion for adhering to the curable plastic 122 to facilitate shearing/breaking of the sealant.

A ratio of the components of the duct sealant 120 may be 60-80% w/w of the curable plastic 122, and approximately 20-40% w/w of the plastic pellets 124, and may preferably be approximately 70% w/w of the curable plastic 122, and approximately 30% of the plastic pellets 124. As the content of the plastic pellets 124 relative to the curable plastic 122 increases the duct sealant 124 becomes easier to break, and as the content of the plastic pellets 124 decreases relative to the curable plastic 122 the duct sealant 124 becomes harder to break.

Further, it is generally desirable to have more plastic pellets 124 each having a smaller volume than less plastic pellets 124 each having a larger volume. For example, the plastic pellets 124 may be spherical pellets having a diameter equal to or less than approximately 3/16 inches.

FIGS. 2A-C show various examples of kits that may be used for preparing the duct sealant as described above. The curable plastic is generally made from at least two components 202a and 202b where one of the components acts as a curing agent, and which when mixed together form bonds that allow a cured solid plastic to form. The two components 202a-b of the curable plastic are stored separately from each other, for example in a single cartridge 204 separated by a breakable membrane 206 or other breakable member (as shown for example in the kit 200a in FIG. 2A and the kit 200b in FIG. 2B), or in two separate cartridges 204a and 204b (as shown for example in the kit 200c in FIG. 2C). The single cartridge 204 shown in FIGS. 2A/B is provided with a dispenser 208 for dispensing the components 202a-b of the curable plastic. The dispenser 208 may also be actuated to perform mixing of the components 202a-b and/or for breaking the breakable membrane 206. In such configuration, the dispenser 208 may extend into the cartridge 204 (not shown). The two cartridges 204a-b shown in FIG. 2C may be provided with a mixing chamber 208a that mixes the components 202a-b before dispensing through dispenser 208b.

Each of the kits 200a-c further comprise the plurality of plastic pellets 124. The plastic pellets 124 may be provided separately (as shown in kit 200a in FIG. 2A and kit 200c in FIG. 2C) and added to the mixture of the curable plastic components 202a-b that are dispensed from the cartridge(s) before curing. Additional mixing may be required to prepare the duct sealant when the pellets 124 are provided separately. Alternatively, the plastic pellets 124 may be provided in one of the components 202a or 202b (as shown in kit 200b in FIG. 2B).

A person skilled in the art will appreciate that the kits 200a-c are provided for the sake of example only, and that kits for preparing the duct sealant may take on different forms, provided that the components 202a-b of the curable plastic and the plastic pellets 124 are included. Kits including at least one cartridge for mixing and dispensing the components 202a-b may help to facilitate preparation in the field by a technician.

FIG. 3 shows a method 300 of sealing a duct. The method 300 comprises preparing a duct sealant compound comprising a curable plastic with a plurality of plastic pellets dispersed throughout the curable plastic (302). For example, the duct sealant compound may be prepared using the kits 200a-c shown in FIGS. 2A-C, and when cured forms the duct sealant 120 as described with reference to FIGS. 1A-C.

The duct sealant compound is inserted into the duct (304). In particular, the duct sealant compound is inserted to fill all voids inside the duct (i.e. any spaces between cables in the duct to an inner surface of the duct wall). The duct sealant compound may be inserted to a thickness of ¾ inches to 1 inch. As described previously, all desired sealing properties can be obtained with this thickness of the duct sealant, and inserting extra duct sealant compound would require more material to be removed when re-entering the duct. Prior to inserting the duct sealant compound into the duct, a backing material may be inserted into the duct (303), for example at a length of ¾ inches to 1 inch from the opening of the duct, to prevent the duct sealant compound from being inserted too far into the duct.

The duct sealant compound is allowed to cure (306). Curing time of the duct sealant compound is temperature-dependent, but is approximately 1 hour at 0 degrees Celsius. The duct sealant as disclosed herein can be cured even at extremely low temperatures (e.g. minus 40 degrees Celsius), and generally has a curing time of between 30 minutes and 2 hours. The quick curing time is beneficial as it allows a technician to visually inspect the cured duct sealant before leaving the site.

It would be appreciated by one of ordinary skill in the art that the system and components shown in figures may include components not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as described herein.

1. A duct sealant, comprising:
a curable plastic; and
a plurality of plastic pellets dispersed throughout the curable plastic.

2. The duct sealant of claim 1, wherein the curable plastic and the plastic pellets have a different hardness.

3. The duct sealant of claim 1, wherein the duct sealant comprises approximately 60-80% w/w of the curable plastic, and approximately 20-40% w/w of the plastic pellets.

4. The duct sealant of claim 1, wherein the plastic pellets are spherical in shape and have a diameter of less than or equal to 3/16 inches.

5. The duct sealant of claim 1, wherein the curable plastic comprises polyurethane.

6. The duct sealant of claim 1, wherein the plastic pellets comprise HDPE.

7. A kit for preparing the duct sealant of claim 1, comprising:
at least one cartridge having stored therein a first component of the curable plastic and a second component of the curable plastic, the first and second components being separated from one another; and
the plurality of plastic pellets.

8. The kit of claim 7, comprising two cartridges that respectively store the first component and the second component of the curable plastic.

9. The kit of claim 7, comprising one cartridge storing both the first component and the second component of the curable plastic, wherein the first component and the second component are separated by a breakable membrane.

10. The kit of claim 7, wherein the plurality of plastic pellets are dispersed in one of the first component or the second component.

11. The kit of claim 7, wherein the plurality of plastic pellets are provided separately from the at least one cartridge.

12. A method of sealing a duct, comprising:
preparing a duct sealant compound comprising a curable plastic with a plurality of plastic pellets dispersed throughout the curable plastic;
inserting the duct sealant compound into the duct; and
allowing the duct sealant compound to cure.

13. The method of claim 12, further comprising:
prior to inserting the duct sealant compound into the duct, inserting a backing material into the duct,
wherein the duct sealant compound is inserted into the duct to extend a length between the backing material and an opening of the duct.

14. The method of claim 12, wherein a curing time of the duct sealant compound is between 30 minutes and 2 hours.

15. The method of claim 12, wherein the duct encloses a fiber optic cable.

16. The method of claim 12, wherein the curable plastic and the plastic pellets have a different hardness.

17. The method of claim 12, wherein the duct sealant compound comprises approximately 60-80% w/w of the curable plastic, and approximately 20-40% w/w of the plastic pellets.

18. The method of claim 12, wherein the plastic pellets are spherical in shape and have a diameter of less than or equal to 3/16 inches.

19. The method of claim 12, wherein the curable plastic comprises polyurethane.

20. The method of claim 12, wherein the plastic pellets comprise HDPE.
